(19) United States
(12) Patent Application Publication
(10) Pub. No.: US 2022/0110378 A1
(43) Pub. Date: Apr. 14, 2022

(54) PERFORMANCE FABRIC PPE FACE MASK

(71) Applicant: Linda Tang, San Jose, CA (US)

(72) Inventor: Linda Tang, San Jose, CA (US)

(21) Appl. No.: 17/359,632

(22) Filed: Jun. 27, 2021

Related U.S. Application Data
(60) Provisional application No. 63/090,624, filed on Oct. 12, 2020.

(51) Int. Cl. A41D 13/11

(52) U.S. Cl. CPC A41D 13/113; A41D 13/1161

(57) ABSTRACT

A durable, reusable, anti-fog, blister-free, sealed face mask that does not slip off the user's face during speech or high-performance activity. The face mask is constructed with anti-viral and antimicrobial wicking, breathable, stretch materials and has an optional filtration membrane. The materials can comprise sustainable recycled materials.

### REFERENCE TO RELATED APPLICATIONS

The present patent application claims priority to U.S. Provisional Patent Application No. 63/090,624, filed on Oct. 12, 2020, the disclosures of which are incorporated herein by reference.

### SUMMARY

The disclosure of the present patent application relates to personal protective equipment (hereinafter “PPE”), particularly face masks.

The Egyptians were the first to use facemasks, they would cast spells on the masks and construct them out of precious metals in order to ward off evil spirits.

The first remotely effective face masks were first used in 17^{th} century Naples, Italy. Plague doctors wore beaked masks that covered their heads, as well as being covered head-to-toe with leather gloves, breeches, boots, and an overcoat. Their masks were filled with herbs to ward off “bad air.” Surprisingly, these herbs had the accidental effect of isolating the user and were sometimes even effective as weak antimicrobial agents.

In the 19^{th} century, face masks started to be worn by factory workers to protect them against airborne particles. In 1897, a French surgeon began wearing facemasks during surgery and noticed a decrease in operation related infections.

Since then, face masks have grown in popularity as a useful way to reduce infection rates, and in 1972 the N95 respirator was invented, becoming a standard for use in epidemics in 1995.

With a current shortage of NIOSH rated masks, and a desire for a semi-protective covering in lower-risk environments, the present invention was conceived of.

With the recent COVID-19 pandemic, there has been an intense level of interest in personal protective equipment (“PPE”), such as face masks. Although public health experts urge widespread use of face masks, however, general compliance has been inadequate.

The big problem is that prior-art face masks tend to be uncomfortable to wear. Among other issues, humid air accumulates and is uncomfortable for the user. If the user wears eyewear, moist air can escape upward, resulting in eyeglass/sunglass fogging.

Partially due to the inadequate performance of prior-art facemasks, hundreds of thousands of Americans have died from COVID-19, and likely hundreds of thousands more will die until the pandemic has run its course. There is thus a compelling public health need for improved PPE devices such as facemasks. Key improvements would be reduction in eyewear fogging, increased comfort, improved seal on the edges of the mask, and increased ergonomics.

The present invention is based, in part, on the insight that face masks often do not provide complete protection from germs and other contaminants because of the loose fit between the surface of the face mask and the user's face. The invention is also based, in part, on the insight that a mask or respirator must fit the user's face snugly to minimize the number of particles, some of which may be infectious, that bypass the filter. Such particles bypass the filter and get into the user's breathing zone through gaps between the user's skin and the respirator seal.

The present invention comprises a durable, reusable, anti-fog, blister-free, sealed face mask that does not slip off the user's face during speech, high-performance activity, or other instances of head or facial movement. The face mask is constructed with anti-viral and antimicrobial wicking breathable stretch materials and has an optional filtration membrane. The fibers that the masks are made of are electrostatically charged which aid in capturing viral particles via electromagnetic attraction and Van der Waals forces. The materials may comprise sustainable recycled materials.

The face mask device is configured to fit over a human user's nose and mouth. The face mask comprises a first outer side configured, when worn by the human user, to face away from the human user; the first outer side comprising any of an air-permeable nylon or polyester fabric; a second inner side configured, when worn by the human user, to face the human user's nose and mouth; the first outer side disposed parallel to and next to the second inner side, so as to form a two-layer structure; the two-layer structure having approximately bilateral symmetry, with opposite sides comprising a left side, a right side, and an axis of symmetry, wherein extreme ends of the left side and the right side are furthest away from the axis of symmetry; wherein, when configured to be worn by the human user, the axis of symmetry is in alignment with an axis of facial symmetry of the human user; the two-layer structure having at least one pleat perpendicular to the axis of symmetry, extending from at least one axis of the face mask, the pleat configured to, at least partially, unfold by application of an external force; the two-layer structure configured with a hollow binding tunnel at each extreme end of the left side and the right side, thereby providing a left hollow binding tunnel and a right hollow binding tunnel; and the face mask device further comprising at least one continuous elastic loop, each at least one elastic loop being configurable to have a section that passes through at least one said hollow binding tunnel, and a section that extends out of at least one said hollow binding tunnel, thus providing at least one loop section configure to be attached to any ears or head or neck of the human user.

The at least one continuous loop of the invention may comprise of two continuous loops; the two continuous loops comprising a left-side loop and a right-side loop, each loop passing through its respective hollow binding tunnel, and extending out of its respective binding tunnel so that each loop is configured to be attached to the ears of the human user.

The at least one continuous loop may also exist as one continuous loop, with the one continuous loop having a section that passes through both the left hollow binding tunnel and the right hollow binding tunnel, the one continuous loop having an upper section configured to attach around an upper portion of the head above the ears, and a lower section configured to attach around the neck.

The invention may further comprise an anti-fog section attached to a top of the two-layer structure, perpendicular to said axis of symmetry, and extending to the extreme ends of the left side and the right side, and attaching to the hollow binding tunnels; the anti-fog section comprising a three-layer material comprising an outer knit backer layer, a middle air-permeable waterproof membrane layer, and an inner brushed knit layer; the anti-fog section configured to condense breath exhalation moisture emitted by the human user, thus reducing moisture content of any air escaping from the top of said device. This construction of the invention may then further comprise a nose bridge comprising a polyethylene-coated metal or metal alloy configured to deform over the nose bridge of the human user. The outer woven or knit backer could also comprise a bonded mix of elastane and any of synthetic nylon or polyester.

The invention may further comprise a plurality of printed dots, said dots comprising anti-viral material, applied to at least said axis of symmetry on any of the first outer side or second inner side. The printed dots may comprise any of copper, titanium dioxide, silver, or other material known to possess high virus inactivating capability. The printed dots may also comprise of UV fluorescing materials, such as titanium dioxide.

The air-filtering facemask device may further comprise a face side inner pocket, positioned between said first outer side and said second inner side, the inner pocket configured to hold a removable filter configured to fit between the first outer side and the second inner side and to provide additional filtration for the human user's nose and mouth. This removable filter may comprise activated charcoal. The removable filter may comprise an air filtration media selected from the group consisting of polypropylene, polyester, nylon, and fiberglass.

Any of the first outer side and second inner side of the air-filtering facemask may comprise a wicking fabric comprising any of a polyester or nylon nano-knit fiber, with any of an antimicrobial, Ultraviolet Protection Factor (hereinafter “UPF”), or wicking finish.

The hollow binding tunnel of the air-filtering facemask may comprise a waterproof Durable Water Repellency (hereinafter “DWR”) material, and the, at least one, continuous elastic loop comprises a high elongation material able to elongate over 150% with about 100% recovery.

The air-filtering facemask may also contain a stiffening rod or strip positioned along the axis of symmetry, configurable when worn by said user to form a separation-bridge between an inner side of the facemasks and a mouth of the user.

An intermediate material may be positioned along the axis of symmetry, so as to separate the left side and right side of the two-layer structure, thus partitioning the mask into a left side two-layer structure, an intermediate material, and a right side two-layer structure.

The, at least one, continuous elastic loop of the air-filtering facemask may have a slider for the means of selectively tightening or loosening the mask against the users face to adjust fit. The at least one continuous elastic loop may also be removably connected to a loop to enable the force of the at least one continuous elastic loop to be redistributed to a different part of the user's head.

### BRIEF DESCRIPTION OF THE DRAWINGS

FIG. 1 shows a side view of a first embodiment of the device.

FIG. 2 shows a side view of an alternative of the first embodiment of the device.

FIG. 3 shows a side view of a second embodiment of the device.

FIG. 4 shows a side view of an alternative of the second embodiment of the device.

FIG. 5 shows a front view of an alternative of the first embodiment of the device.

FIG. 6 shows a front view of an alternative of the second embodiment of the device.

FIG. 7 shows a front view of a different alternative of the second embodiment of the device.

FIG. 8 shows a back view of the first embodiment of the device.

FIG. 8A shows additional details and cross-sections of the first embodiment of the device.

FIG. 9 shows a back view of an alternative of the first embodiment of the device.

FIG. 10 shows a back view of the second embodiment of the device.

FIG. 11 shows a back view of the second embodiment of the device.

FIG. 11A shows additional details and cross-sections of the second embodiment of the device.

FIG. 12 shows a view of a removeable filter insert for the second embodiment of the device.

FIG. 13 shows a view of a removeable filter insert for the first embodiment of the device.

FIG. 14 shows how the removeable filter insert can fit into the inner pocket of a first embodiment of the device.

FIG. 15 shows how the removeable filter insert can fit into the back pocket of a second embodiment of the device.

FIG. 15A shows additional details and cross-sections of the second embodiment of the device.

FIG. 16 shows how the removeable filter insert can fit into the back pocket of an alternative of the second embodiment of the device.

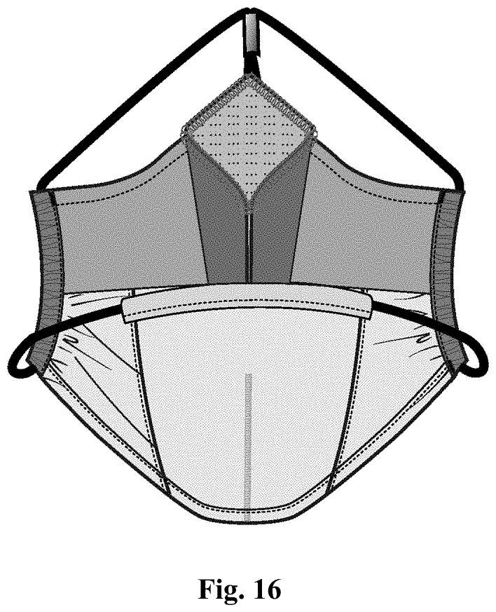

### DETAILED DESCRIPTION

For the purposes of this disclosure, “antimicrobial” may mean a substance or material that kills or slows the spread of microorganisms. Microorganisms may include at least bacteria, viruses, protozoans, and/or fungi.

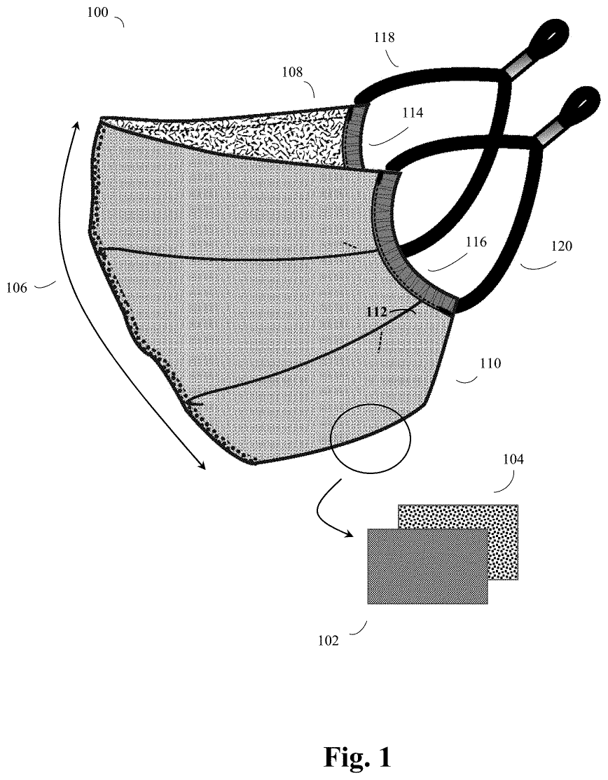

A first embodiment of the face mask device is as shown in FIG. 1.

In some embodiments, the invention may he an air-filtering face mask device 100 configured to fit over a human user's nose and mouth. This air-filtering face mask will typically comprise a first outer side 102 configured, when worn by a human user, to face away from the human user. This first outer side will typically comprise any of air-permeable nylon or polyester fabric. In a preferred embodiment, this fabric may be a wicking fabric, and preferably a renewable, recycled, or sustainably sourced synthetic fabric or biodegradable fabric.

The facemask device will often comprise a second inner side 104 configured, when worn by the human user, to face the human user's nose and mouth.

The first outer side 102 is generally disposed parallel to, and next to, the second inner side 104, to form a two-layer structure. This two-layer structure is configured to cover the nose and mouth of the user. It will generally have bilateral symmetry, with opposite sides comprising a left side, a right side, and an axis of symmetry 106. Here the extreme ends of the left side 108 and the right side 110 are furthest away from the axis of symmetry 106.

When configured to be worn by the human user, this axis of symmetry 106 aligns with an axis of facial symmetry of the human user (e.g., the axis of symmetry of the human user's face).

This two-layer structure 102, 104 will typically have at least one pleat (often two, three, or even more pleats 112) located in lower jaw area. These pleats may be configured to unfold and expand when worn by the user, and then elastically reform back into the original one or more pleats after wearing. These pleats allow for expansion of the mask while talking, breathing and moving the head. This reduces particle intrusion during these activities and helps to achieve a better seal. This at least one pleat 112 will generally be perpendicular to the axis of symmetry 106, and the pleat(s) will typically extend from the extreme left side 108 to the extreme right side 110. These pleats will typically be configured to, at least partially, unfold by application of external force applied manually by the human user when putting on the facemask device. Usually, pleats have the disadvantage of deceasing the seal and allowing more air to enter the mask. These pleats are designed with the mask to seal around the perimeter of the mask and to elastically contract when the extra space isn't required.

DWR is a treatment/finish applied to a fabric/material for waterproofness. DWR is a replacement for an earlier waterproofing material called C8, made from highly fluorinated chemicals, which can be toxic. C8 is based on perfluoroalkyl chains with eight or more fluorinated carbons. In a preferred embodiment, the invention's mask devices will comprise sustainable, non-toxic alternative chemistries for water repellency purposes, such as CO or non-fluoridated materials. C0 is a version of water repellent chemical that is non-fluorinated, making it less harmful to ourselves and the environment.

Each end of this two-layer structure is also configured with a hollow binding tunnel 114, 116, typically comprised of a flexible, lightweight, waterproof, DWR material. DWR material is preferred because this type of material repels droplets from the mask and wearers face. Repelling droplets is desirable because if the droplets stay on the facemasks, there will be a higher probability of contamination. This is because most airborne pathogens require a minimum level of humidity, or water, to survive and the waterproof material reduces the range or pathogens and duration of contamination on the mask. The hollow binding tunnels 114, 116, positioned at each end of the left side and the right side, thereby provide a left hollow binding tunnel and a right hollow binding tunnel. The hollow aspect of the tunnel also increases comfort for the user as the deformation they allow for increases contact area with the face and decreases the pressure per square inch. The three-dimensional deformation instead of traditional two-dimensional deformation also helps to reduce the elastic forces felt by the user.

The air-filtering facemask device 100 will typically further comprise at least one continuous elastic loop 118, 120. These at least one elastic loop(s) are configurable to have an inside section that passes through at least one hollow binding tunnel and an outside section that extends out of the hollow binding tunnel(s). This provides at least one loop section configured to be attached to any of the ears or head or neck of the human user. This loop section is typically configured to move freely through the hollow binding tunnels, allowing for full adjustability for the human user. The elastic loop can be worn over the ears, the head, or neck, The device can be attached over the upper portion of the user's head, above the user's ears only. Alternatively, the device can be converted to be worn on with an upper portion of the loop around the user's head and lower portion of the loop around the user's neck.

In some embodiments, this at least one continuous loop can comprise two continuous loops 118, 120. These two continuous loops can comprise a left-side loop 118 and a right-side loop 120, each loop passing through its respective hollow binding tunnel 114, 116, and extending out of its respective binding tunnel so that each loop is configured to be attached to the ears of the human user.

In a preferred embodiment, the loops can elongate from an initial loop diameter from about three inches to about nine inches diameter for an extended time (e.g., hours, during wear). After this elongation period, the loops can then contract back to their original dimensions. This process is called “recovery.” Recovery is calculated by how long it will take to contact back to the original diameter over some time, These properties can be tested based on a modified version of the ASTM D4964 standard for tension and elongation of elastic fabrics.

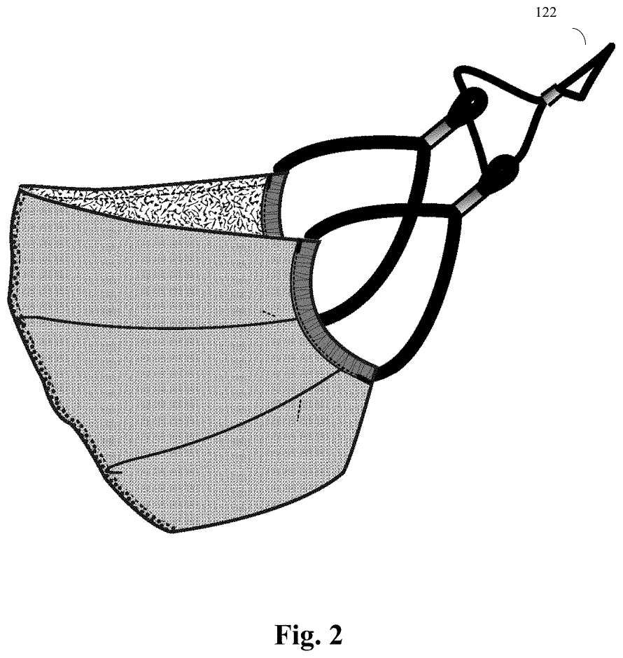

In an embodiment of the presently disclosed invention, the one or more loops may move freely through the tunnels 116, 114, allowing full adjustability for the human user. The tunnels are made from a flexible, light, but durable material with an inner air-permeable waterproof membrane that can be scrunched/gathered or expanded to fit the user's lower jaw or ramus area. This area is frequently unprotected in face masks because they are often made out of rigid materials that do not expand while the user is moving. The continuous loops may also have additional attachments FIG. 2, 122 that allow the loops to connect for the user to wear over the user's head or behind the user's neck.

FIG. 2 shows a side view of an alternative embodiment of the first embodiment of the device where the continuous loops have an additional attachment. In this embodiment two continuous loops may be connected 122 by a third continuous loop. This third continuous loop may be tightened or loosened using a slider to affect a tightening of the face mask against the human user's face.

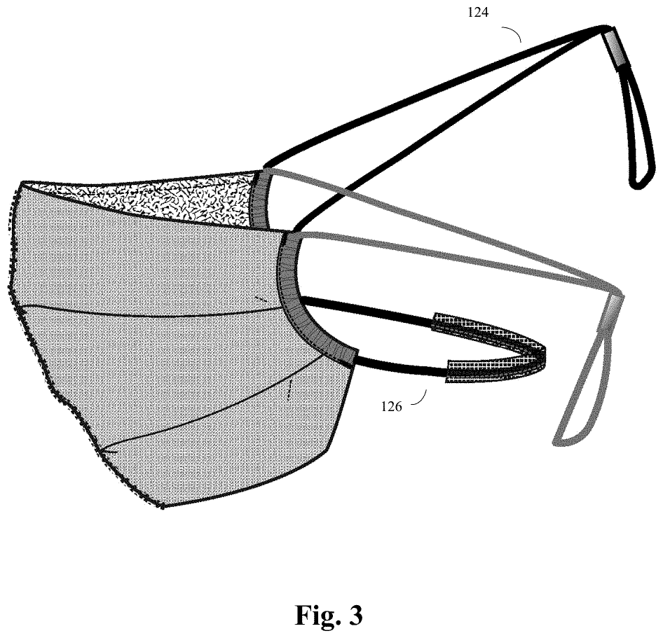

FIG. 3 shows a side view of a second embodiment of the device, containing an upper 124 and lower 126 section of one continuous loop. In the embodiment shown in FIG. 3, at least one continuous loop may be one continuous loop. This one continuous loop can have a section that passes through both the left hollow binding tunnel and the tight hollow binding tunnel. This one continuous loop can have an upper section 124 configured to attach around an upper portion of the head above the ears, and a lower section 126 configured to attach around the neck.

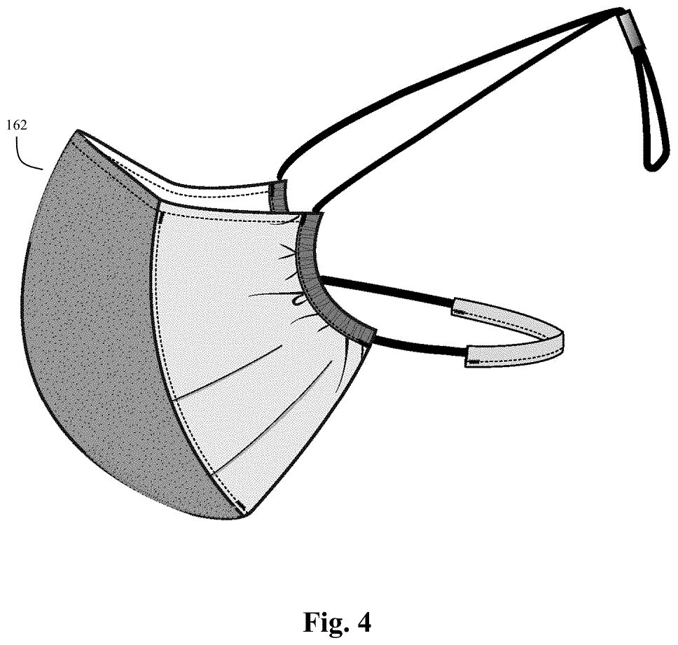

FIG. 4 shows a side view of an alternative embodiment of the second embodiment of he device. This alternative embodiment shows an intermediate material 162 positioned. approximately along the axis of symmetry separating the left side, and right side, of the two-layer structure, thus partitioning the face mask into a left side of the two-layer structure, an intermediate material (162), and a right side of the two-layer structure.

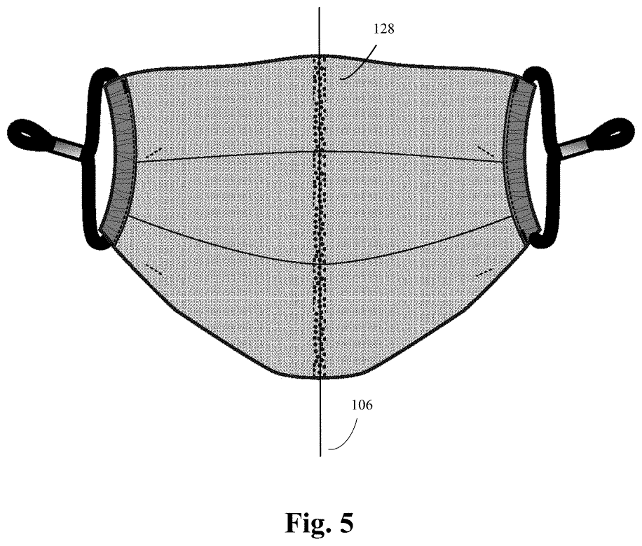

FIG. 5 shows a front view of an alternative embodiment of the first embodiment of the device. FIG. 5 shows a plurality of printed dots 128 applied to at least the axis of symmetry on any of the first outer side, or second inner side. These dots may comprise an antimicrobial or anti-virus material for the purpose of neutralizing an amount of pathogens the printed dots make contact with. Antimicrobial particles that may be used include colloidal silver (such as a suspension of majority pure silver particles combined with silver ions); copper, and titanium dioxide, and other metals that will interact with the valence electrons in microbial particles. Titanium dioxide can further act as a photocatalyst using ultraviolet light and is not consumed in the reaction. Thus, in some embodiments, the printed dots can comprise any of copper, titanium dioxide, colloidal silver, or other material known to possess high virus inactivating capability.

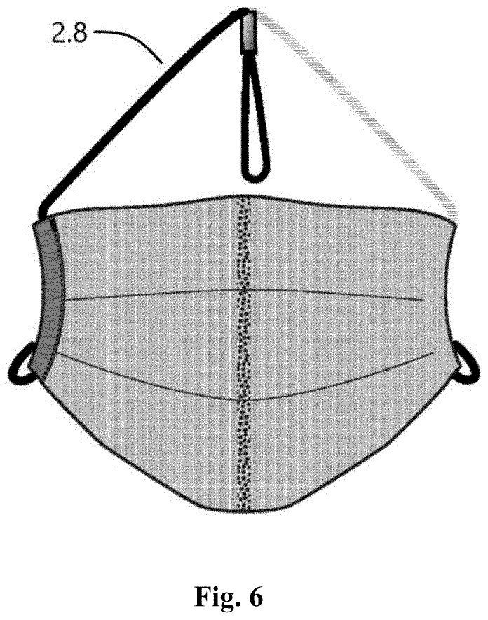

FIG. 6 shows a front view of an alternative embodiment of the second embodiment of the device. The embodiment depicts retention straps 2.8 that laterally transverse the head of the user and with a slider to adjust the tension against the head of the user.

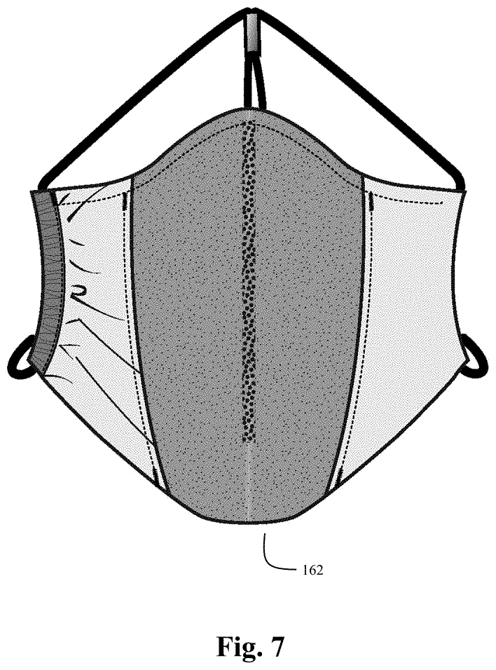

FIG. 7 shows a front view of the embodiment shown in FIG. 4. FIG. 7 shows the intermediate material 162 positioned approximately along the axis of symmetry, with the left side and the right side of the two-layer structure adjacent to the intermediate material.

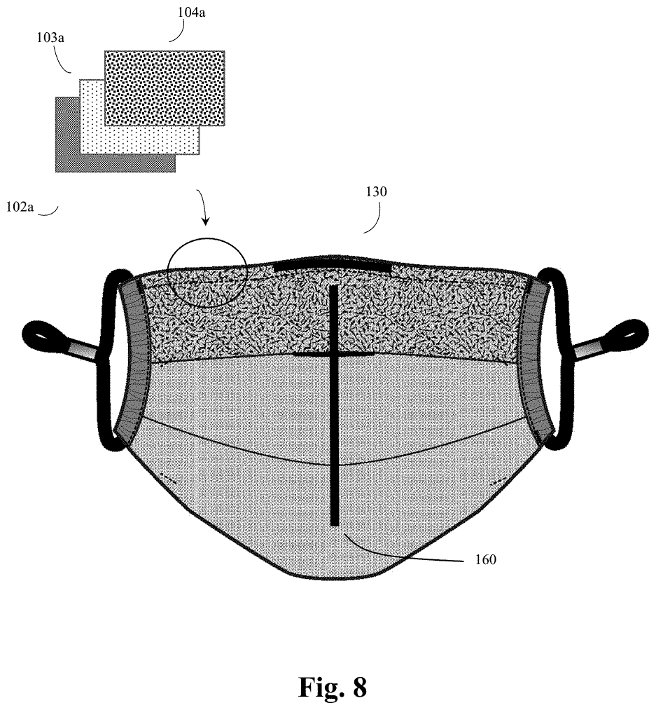

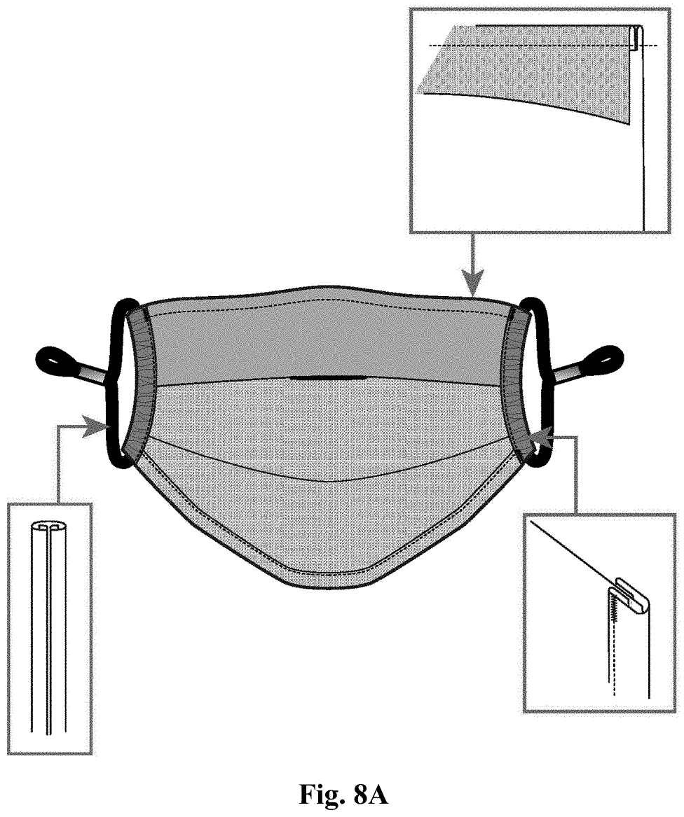

FIG. 8 shows a back view of the first embodiment of the device in which the device may further comprise an anti-fog section 130 attached to a top of the two-layer structure, perpendicular to the axis of symmetry, and extending to the extreme ends of the left side and the right side, and attaching to the hollow binding tunnels. In some embodiments, this anti-fog section can comprise a three-layer material comprising an outer knit backer layer 102a, a middle air-permeable waterproof membrane layer 103a, and an inner brushed knit layer 104a. This anti-fog section may be configured to condense breath exhalation moisture emitted by the human user, thus reducing the moisture content of any air escaping from the top of the device. The outer knit back layer 102a, or other layers, may comprise a bonded mix of elastane and any of synthetic nylon or polyester.

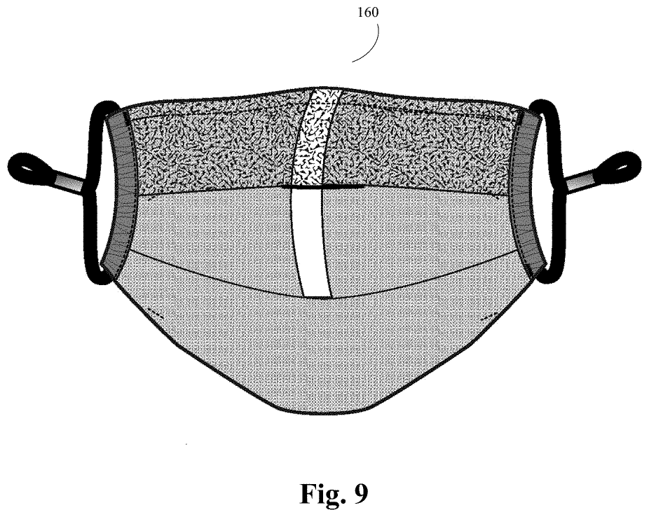

A stiffening rod can be seen in FIG. 8 160, and in FIG. 9 160. This stiffening rod may be positioned along the axis of symmetry and is bendable so it may be configured by the user, when worn, to form a separation bridge FIG. 8, 160 between the inner side of the facemask and the user's mouth.

This stiffening rod or strip 160, here called a “mouth bridge,” is typically positioned perpendicular to any nose bridge 130. This mouth bridge acts to provide a “second liner side” arch to create space away from the user's mouth as shown in an alternate depiction in FIG. 9 160. The invention's combination of engineered pleats FIG. 1, 112 and the mouth bridge FIG. 8, 160 construction makes it easier for the wearer to breathe, speak and yawn without unwanted mask movement (or gaps) away from the wearer's nose or chin. It also helps prevent the inner liner side fabric from entering the wearer's mouth, which increases sanitation for the wearer.

In some embodiments, as shown in FIG. 8, the device may further comprise a nose bridge 130 comprising a polyethylene-coated metal or metal allow configured to undergo plastic deformation over the nose bridge of the human user when an external force is applied. The polyethylene-coated metal or metal ahoy nose bridge has the advantage of being a composite material and increases the durability of the face mask.

FIG. 8A shows additional details and cross-sections of the first embodiment of the device, specifically the structure of the continuous elastic loops, the hollow binding tunnels, and an axis traversing top and bottom of the mask.

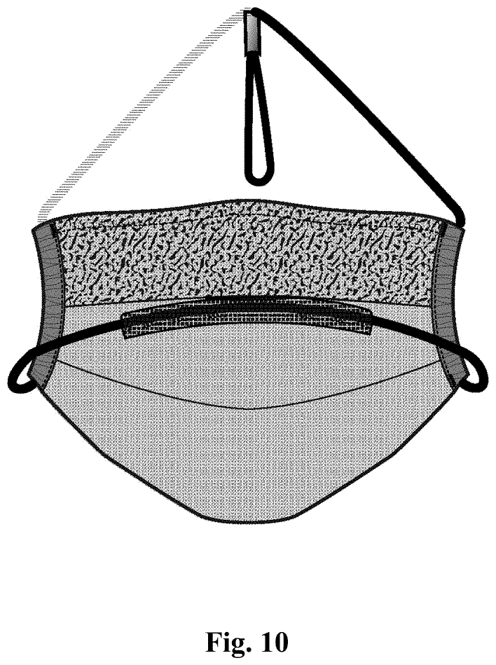

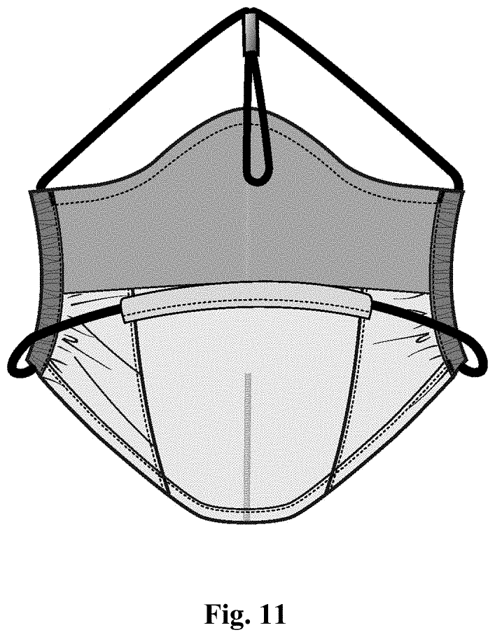

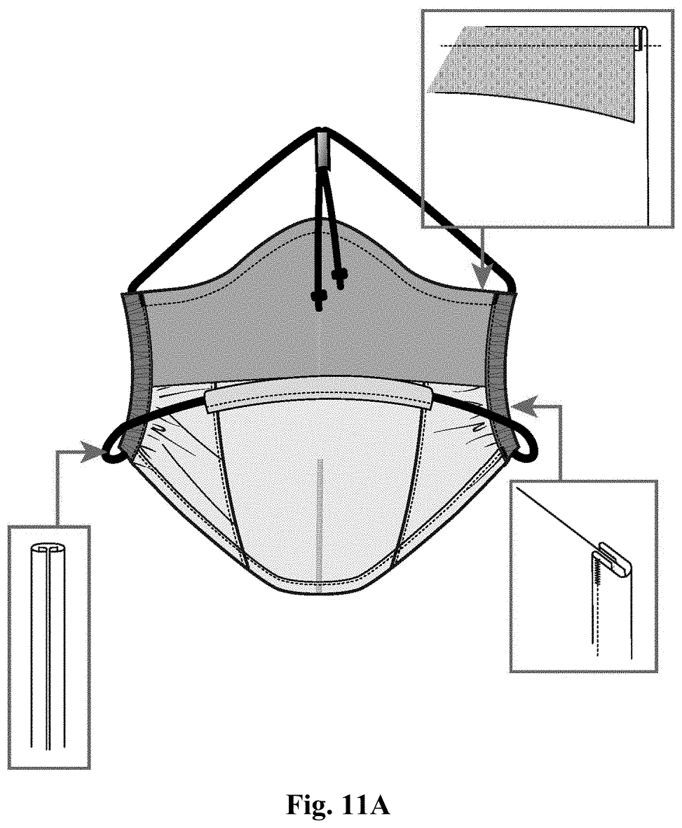

In FIG. 10, the second embodiment of the device shows a possible horizontal configuration of one of the continuous elastic loops. A back view of the second embodiment of the device is shown in FIG. 11, and FIG. 11A shows additional details and cross-sections of the second embodiment of the device, specifically the structure of the continuous elastic loops, the hollow binding tunnels, and the top and bottom axis of the mask.

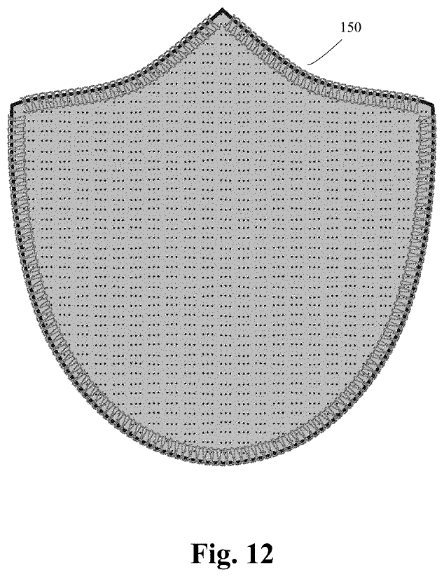

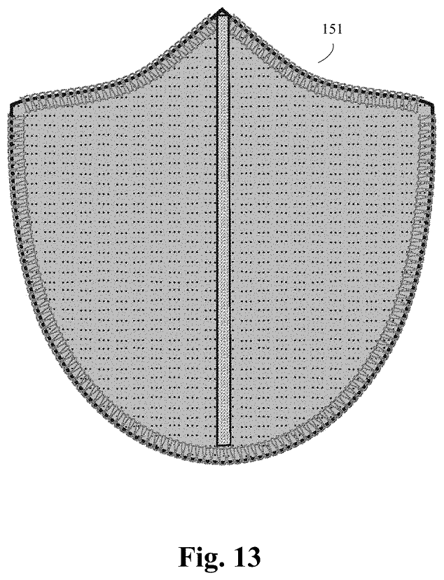

A removeable filter insert for the second embodiment of the device FIG. 12, 150 may be inserted into the second embodiment of the device to provide additional air filtration. A removable filter insert for the first embodiment of the device FIG. 13, 151 may also be inserted into the first embodiment of the device.

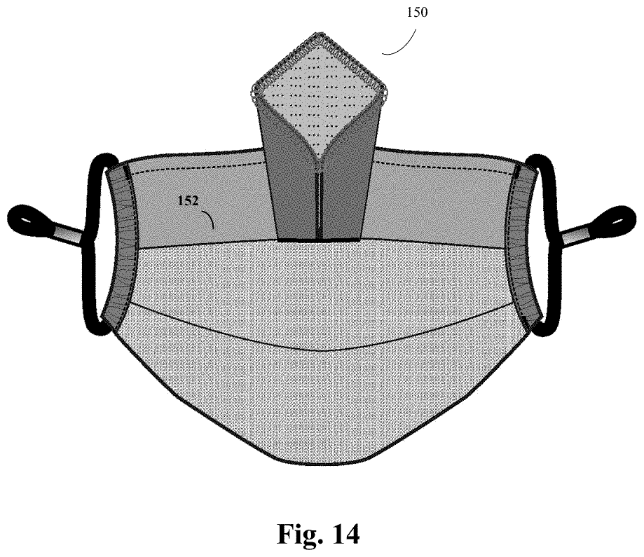

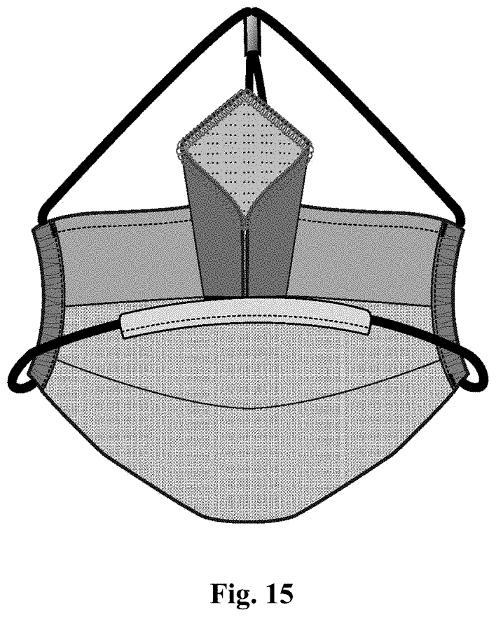

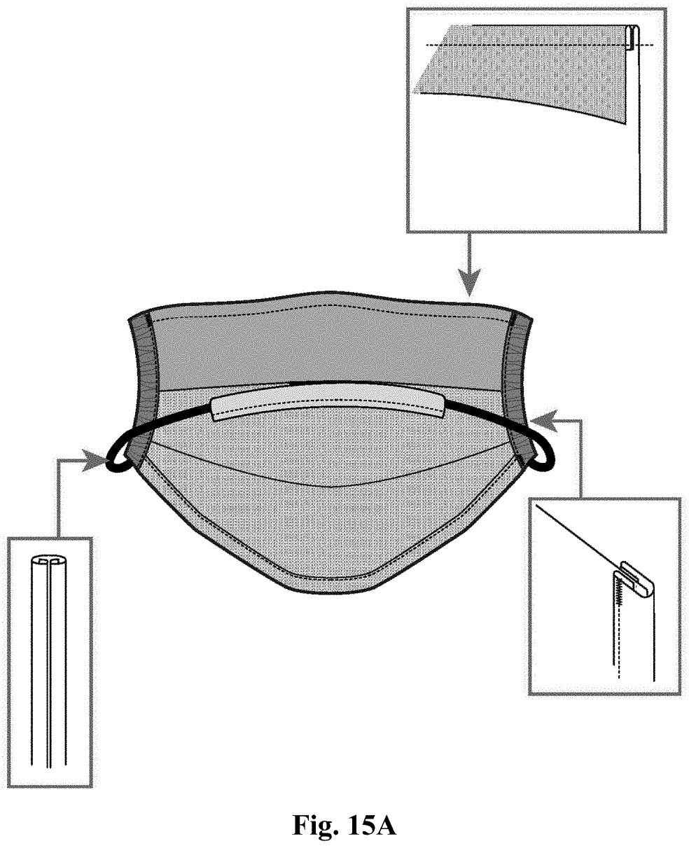

In the second FIG. 14, and first FIG. 15 embodiments, the device may further comprise a face side inner pocket FIG. 14, 152, positioned between the first outer side and the second inner side, the inner pocket configured to hold a removable filter (150 or 151 shown in FIG. 12 and FIG. 13). This filter 150 or 151 is configured to unfold and fit between the first outer side and the second inner side and to provide additional filtration for the human user's nose and mouth. The additional filtration can be from a variety of materials. The wearer could insert more antimicrobial materials or could also insert odor absorbing agents such as activated charcoal which has the added benefit of also reducing inhalation of air pollution and reactive ozone molecules.

FIG. 15A shows additional details and cross-sections of the second embodiment of the device, specifically the structure of the continuous elastic loops, the hollow binding tunnels, and the top and bottom axis of the mask.

In some embodiments, the removable filter comprises non-woven Polypropylene, or cotton woven (80-120 thread), or spacer mesh poly (bra pad Muslin+sponge), or HEPA filter, or Scotts Blue shop towel, or a combination of some or all of the above. Such materials can block out percentages of particles with diameters above 0.3 microns.

In some embodiments, any of the first outer side 102 and the second inner side 104 can comprise a wicking fabric comprising any of a polyester or nylon nano-knit fiber, with any of an antimicrobial, UPF, or wicking finish In a preferred embodiment, such nano-knit fibers have mechanical stretch characteristics and can be made from recycled polyester or nylon. These fibers are preferably treated with an antimicrobial, UPF and wicking finish. These materials can be combined permanently with “removeable filter materials” for more protection and structure.

Nano knit is a blend of stretch fiber and super-micro polyamide yarn. Nano knit is preferred because this material can provide comfort and a second-skin feel for the user. This also increases the thread count of the mask and increases surface area, the increased surface area increase the chance of electrostatic interactions with airborne particles allowing more effective filtration. In Nano knit fibers, the denier of yarn is nano-sized (standard term in the industry).

Although both the outer/shell and inner/liner sides may be made of the same fabric, in some embodiments (see FIG. 4, FIG. 7), there will be an additional center non-stretch filter material with specific engineered shape and optimal size will be bonded or stitched on for more protection and structure without restricted movement or breaking mask seal. Lower chin panel will extend and flex with functional pleats and stretch material.

In some embodiments, the hollow binding tunnel(s) 114, 116 can comprise a waterproof DWR material. The at least one continuous elastic loop preferably comprises a high elongation material able to elongate at least over 150% (and as much as 300%) with 100% recovery.

What is claimed is:

1. An air-filtering face mask device configured to fit over at least a human user's nose and mouth, the air-filtering face mask comprising:
a first outer side configured, when wort by the human user, to face away from the human user;
the first outer side comprising any of an air-permeable nylon or polyester fabric;
a second inner side configured, when worn by the human user, to face the human user's nose and mouth;
the first outer side disposed parallel to and next to the second inner side, so as to form a two-layer structure;
the two-layer structure having bilateral symmetry, with opposite sides comprising a left side, a right side, and an axis of symmetry, wherein an extreme end of the left side and an extreme end of the right side are furthest away from the axis of symmetry;
wherein, when configured to be worn by the human user, the axis of symmetry is in alignment with an axis of facial symmetry of the human user;
the two-layer structure having at least one pleat, perpendicular to the axis of symmetry, extending from at least one axis of the mask, the pleat configures, at least, to partially unfold by application of an external force;
the two-layer structure configured with a hollow binding tunnel at each extreme end of the left side and the right side, thereby providing a left hollow binding tunnel and a right hollow binding tunnel; and
the air-filtering face mask device further comprising at least one continuous elastic loop, the at least one elastic loop being configurable to have a section that passes through at least one said hollow binding tunnel, thus providing at least one loop section configured to be attached to any of ears, head, or neck of the human user.

2. The air-filtering face mask device of claim 1, wherein the at least one continuous loop comprises two continuous loops;
the two continuous loops comprising a left-side loop and a right-side loop, the left-side loop and the right-side loop passing through its respective hollow binding tunnel and extending out of its respective binding tunnel so that the left-side loop and the right-side loop is configured to be attached to the ears of the human user.

3. The air-filtering face mask device of claim 1, wherein the at least one continuous loop is one continuous loop, the one continuous loop having a section that passes through both the left-side hollow binding tunnel and the right-side hollow binding tunnel, the one continuous loop having an upper section configured to attach around an upper portion of the head above the ears of the human user, and a lower section configured to attach around the neck of the human user.

4. The air-filtering face mask device of claim 1, further comprising an anti-fog section attached to a top of the two-layer structure, perpendicular to the axis of symmetry, and extending to the extreme ends of the left side and the right side, and attaching to the left side hollow binding tunnel, and the right side hollow binding tunnel;
the anti-fog section comprising a three-layer material comprising an outer knit backer layer, a middle air-permeable waterproof membrane layer, and an inner brushed knit layer;
the anti-fog section configured to condense breath exhalation moisture emitted by the human user, thus reducing moisture content of any air escaping from the top of the air-filtering face mask device.

5. The device of claim 4, further comprising a nose bridge comprising a polyethylene-coated metal or metal alloy configured to deform over the nose bridge of the human user.

6. The device of claim 4, wherein the outer woven or knit backer comprises a bonded mix of elastane and any of synthetic nylon or polyester.

7. The air-filtering face mask device of claim 1, further comprising a plurality of printed dots, the plurality of printed dots comprising an anti-viral material, applied to at least the axis of symmetry on any of the first outer side or second inner side.

8. The device of claim 7, wherein the plurality of printed dots comprise any of copper, titanium dioxide, silver, or other material known to possess high virus inactivating capability.

9. The device of claim 7, wherein the plurality of printed dots comprise of photocatalytic materials, such as titanium dioxide, applied to at least the axis of symmetry on any of the first outer side or second inner side.

10. The device of claim 7, whereon the plurality of printed dots comprise of antimicrobial materials of the group including colloidal silver, copper, and titanium dioxide, applied to at least the axis of symmetry on any of the first outer side or second inner side.

11. The air-filtering face mask device of claim 1, further comprising an inner pocket, positioned between the first outer side and the second inner side, the inner pocket configured to hold a removeable filter configured to fit between the first outer side and the second inner side.

12. The device of claim 11, wherein the removable filter comprises activated charcoal.

13. The air-filtering face mask device of claim 1, wherein any of the first outer side and the second inner side comprises a wicking fabric comprising any of a polyester or nylon nano-knit fiber, with any of an antimicrobial, UPF, or wicking finish.

14. The air-filtering face mask device of claim 1, wherein the hollow binding tunnel comprises a waterproof Durable Water Repellency material, and the at least one continuous elastic loop comprises a high elongation material able to elongate over 150% with about 100% recovery.

15. The air-filtering face mask device of claim 1, further comprising a stiffening rod or strip positioned along the axis of symmetry, configurable when worn by the human user to form a separation-bridge between the second inner side of the face mask and mouth of the human user.

16. An air-filtering face mask device, comprising:
a first outer side configured, when worn by the human user, to face away from the human user;
the first outer side comprising any of an air-permeable nylon or polyester fabric; a second inner side configured, when worn by the human user, to face the human user's nose and mouth;
the first outer side disposed parallel to and next to the second inner side, so as to form a two-layer structure;
the two-layer structure having bilateral symmetry, with opposite sides comprising a left side, a right side, and an axis of symmetry, wherein an extreme end of the left side and an extreme end of the right side are furthest away from the axis of symmetry;
wherein, when configures to be worn by the human user, the axis of symmetry is in alignment with an axis of facial symmetry of the human user;
an intermediate material positioned along the axis of symmetry, so as to separate the left side and the right side of the two-layer structure, therefore partitioning the face mask into a left side two-layer structure, and intermediate material, and a right side two-layer structure;
the two-layer structure having at least one pleat, perpendicular to the axis of symmetry, extending from at least one axis of the mask, the pleat configures, at least, to partially unfold by application of an external force;
the two-layer structure configured with a hollow binding tunnel at each extreme end of the left side and the right side, thereby providing a left hollow binding tunnel and a right hollow binding tunnel; and
the air-filtering face mask device further comprising at least one continuous elastic loop, the at least one elastic loop being configurable to have a section that passes through at least one said hollow binding tunnel, thus providing at least one loop section configured to be attached to any of ears, head, or neck of the human user.

17. The device of claim 11, wherein the removable filter comprises an air filtration media selected from the group consisting of polypropylene, polyester, nylon, and fiberglass.

18. The air-filtering face mask device of claim 1, wherein the at least one continuous elastic loop has a slider for the means of selectively tightening or loosening the face mask against the human user's face to adjust fit.

19. The air-filtering face mask device of claim 1, wherein the at least one continuous elastic loop is removably connected to a loop to enable the force of the at least one continuous elastic loop to be redistributed to a different part of the human user's head.
